(19) United States
(12) Patent Application Publication
(10) Pub. No.: US 2008/0125535 A1
(43) Pub. Date: May 29, 2008

(54) Thermoplastic Polymer Based Nanocomposites

(76) Inventors: Ke Wang, Singapore (SG); Chaobin He, Singapore (SG); Ling Chen, Singapore (SG); Mei Ling Toh, Singapore (SG); Khine Yi Mya, Singapore (SG)

Correspondence Address: Richard S Wesorick;Tarolli Sundheim Covell & Tummino, 1300 East Ninth Street, Suite 1700, Cleveland, OH, 44114, US

(21) Appl. No.: 11/795,208

(22) PCT Filed: Jan. 14, 2005
(86) PCT No.: PCT/SG05/00006

§ 371 Date: Jul. 13, 2007

(51) Int. Cl. C08K 3/00

(52) U.S. Cl. 524/445

(57) ABSTRACT

Thermoplastic nanocomposites are prepared by reactive compounding of a nanocomposite versatile masterbatch comprising a partially modified pristine clay and a reactive carrier plastics compound with a thermoplastics matrix polymer wherein the matrix polymer has a main chain directly or indirectly miscible with or reactive with said carrier plastics compound. The matrix polymer may include functional groups reactive with the carrier plastics compound to form a copolymer or a copolymer having at least one region thermodynamically miscible with said matrix polymer and at least one functional group reactive with said reactive carrier plastics compound to form a block copolymer therebetween.

### FIELD OF THE INVENTION

This invention is concerned with the manufacture of polymer/clay nanocomposites produced by a reactive compounding process.

The invention is concerned particularly, although not exclusively, with the manufacture of polymer/clay nanocomposites by reactive compounding of a matrix polymer with an exfoliated clay-containing versatile masterbatch having a reactive plastics carrier compound.

### BACKGROUND OF THE INVENTION

Clay-based polymer nanocomposites offer substantial improvements in physical properties over conventional polymeric materials. In particular, improvements in mechanical, thermal, fire retardancy and gas barrier properties already have been exhibited in a wide range of polymeric materials where layered inorganic fillers can be dispersed as plate-like nanoparticles throughout a polymer matrix.

In order to maximize the physical properties of polymer/clay nanocomposites it is necessary to maximize the degree of delamination or exfoliation of clay platelets to obtain an even dispersion thereof through the polymer matrix. An ideal dispersion comprises an even substantially random distribution of individual platelets of say, montmorillonite which have a thickness of about 1 nm and a diameter of 1 μm thereby giving aspect ratios in the range of about 1000:1 thus providing an extremely high surface area to volume ration. The presence of undispersed clumps of clay particles or “tactoids” can substantially reduce the physical properties otherwise available where dispersion approaches an “ideal” or complete exfoliation.

It is well known in the prior art that cost effective dispersion of fully exfoliated clay platelets is both difficult and rarely achieved. Early nanocomposites were based on Nylon 6 produced in the polymerization reactor. Of more recent times, the focus has been on achieving exfoliation in a melt compounding process to enable a wider range of polymeric clay nanocomposite species. Unfortunately, of the many melt compounding processes described in the literature, many of these do not permit a sufficient degree of exfoliation of clay particles or otherwise are limited to a narrow range of polymeric matrices.

Many of the prior art processes employ an organically modified clay wherein otherwise hydrophilic clays are treated with organic modifiers to render the clay particles organophilic or more miscible with hydrophobic polymers in particular. Alkyl ammonium surfactants are the most commonly employed organic modifiers which effect an ionic exchange with hydrated cations bound between platelet stacks in regions known as “interlayers” or “galleries”. The alkyl-ammonium exchanged clay can then be intercalated by an organic swelling agent such as ethylene glycol, naphtha or heptane which can then be melt processed to allow polymer penetration into the clay galleries. Typically these clay filled polymers can include up to 60 weight percent of organoclay dispersed as exfoliated platelets, disordered clumps and intercalated tactoids.

In other prior art processes it has been proposed to utilize a hydroxy functionalized polypropylene oligomer and an organoclay, or a maleic anhydride-modified polypropylene oligomer and a stearylammonium-intercalated clay.

Yet another prior art process proposed the use of ammonium—functionalized polymers or oligomers wherein the ammonium—functionalized polymer or oligomer was first melt compounded with up to 60 weight percent clay to form a concentrate which was then melt compounded with a matrix polymer compatible with the functionalized oligomer or polymer, both preferably having the same monomer unit.

One of the difficulties in forming highly exfoliated dispersions of clay in nanocomposites is that for certain polymeric matrices, such nanocomposites are thermodynamically unstable and do not readily lend themselves to further processing in, for example, thermoplastics matrices. Effective dispersion of highly exfoliated clays in non-polar thermoplastics polymers such as polyolefins and polystyrenes has been quite difficult and not cost effective. From the outset, modified organoclays were required to permit intercalation of the polymeric matrix and, depending upon the nature of the polymeric species, low molecular weight compatibilizers were required to facilitate intercalation of the polymeric species into the clay galleries.

Typically, an organoclay comprises from 25 to 45 wt % of a modifier such as an alkylammonium salt to render the clay more organophilic and thus susceptible to intercalation.

To improve dispersion and exfoliation of an organoclay in non-polar polymers a low molecular weight copolymer such as maleic anhydride grafted polypropylene (PP-g-MAH) is often employed. A difficulty with such prior art nanocomposites is that the presence of low molecular weight modifier molecules and low molecular weight polymers substantially deteriorates both mechanical and thermal properties of the resultant nanocomposite.

While generally effective, to a greater or lesser extent, for their intended purpose, these prior art polymer/clay nanocomposites have all suffered from the requirement for expensive organically modified clays, limitations on polymer choices and processing limitations to avoid degradation of the polymer matrix. At the same time, the degree of exfoliation of the clay filler varies greatly from one prior art process to another.

One of the more serious shortcomings associated with the use of organoclays is the presence of residual small organic modifier molecules in the resultant nanocomposite, which residual small molecules can detract from the thermal and mechanical properties otherwise obtainable.

Accordingly, it is an aim of the present invention to overcome or ameliorate at least some of the disadvantages of the prior art and otherwise provide greater degree of choice in the preparation of nanocomposites and the nanocomposites so obtained.

### SUMMARY OF THE INVENTION

In accordance with one aspect of the invention there is provided a thermoplastic polymer based nanocomposite prepared by reactive compounding of:—

a nanocomposite masterbatch comprising a carrier plastics compound having one or more carrier functional groups and an exfoliated clay dispersed throughout said carrier plastics compound; and,

a thermoplastic matrix polymer, said matrix polymer having a main chain directly or indirectly miscible with or reactive with said carrier plastics compound.

Suitably, said carrier plastics compound may comprise a monomer, oligomer or polymer or any combination thereof.

If required said one or more carrier functional groups may be selected from epoxy, hydroxyl, amine, isocyanate, carboxyl or any combination thereof.

Preferably, said carrier plastics compound comprises an epoxy prepolymer or polyethylene oxide.

Said thermoplastic matrix polymer may be directly miscible with said carrier plastics compound and where said carrier plastics compound comprises a monomer, oligomer, prepolymer or any combination thereof, a curing agent may be provided to effect cross linking of said monomer, oligomer, prepolymer or any combination thereof during reactive compounding of said nanocomposite.

If required, said thermoplastic matrix polymer may include one or more matrix functional groups reactive with carrier functional groups via chain extension or cross linking during reactive compounding to form a carrier/matrix copolymer between said carrier plastics compound and said matrix polymer.

Suitably, the thermoplastic polymer is selected from the group comprising:—

crystalline polar thermoplastic polymers, crystalline non-polar thermoplastic polymers, non-crystalline non-polar thermoplastic polymers, non-crystalline polar thermoplastic polymers; copolymers thereof or any combination of the aforesaid polymers.

Said nanocomposite may include a reactive polymer having at least one segment thermodynamically miscible with said matrix polymer and at least one region having at least one reactive polymer functional group reactive with a carrier functional group during reactive compounding to form a carrier/reactive copolymer between said carrier plastics compound and said reactive polymer.

Suitably, said at least one reactive polymer functional group is selected from carboxyl, hydroxyl, isocyanate, amine, epoxy or any combination thereof.

The reactive polymer may be selected from a group comprising blocks, segments or chains having the same monomer unit as said matrix polymer or are thermodynamically miscible therewith.

Preferably, said nanocomposite masterbatch is formed by treatment of pristine clay with water to swell said clay, exchanging said water with an organic solvent while maintaining said clay in a swollen state, treating said solvent exchanged swollen clay with a modifier selected from a surfactant, a coupling agent, a compatibilizer or any combination thereof and subsequently mixing said clay so treated with a monomer, oligomer, polymer or combinations and selectively removing said solvent from said nanocomposite masterbatch.

The nanocomposite masterbatch may include clay in an amount of from between 2% and 80% by weight of the masterbatch.

Preferably, said thermoplastic polymer based nanocomposite comprises from 0.1% to 20% by weight of clay based on the total weight of the nanocomposite.

According to another aspect of the invention there is provided a process for the formation of a thermoplastic nanocomposite said process including reactive compounding of a nanocomposite masterbatch comprising a plastics carrier compound having one or more carrier functional groups and an exfoliated clay dispersed throughout said carrier plastics compound and a thermoplastic matrix polymer, said matrix polymer having a main chain directly or indirectly miscible with or reactive with said carrier plastics compound.

Suitably, said carrier plastics compound is selected from monomers, oligomers, polymers or any combination thereof.

If required, said carrier functional groups may be selected from epoxy, hydroxyl, amine, isocyanate, carboxyl or any combination thereof.

Preferably said carrier plastics compound comprises an epoxy prepolymer or polyethylene oxide.

Where said thermoplastic matrix polymer is directly miscible with said carrier plastics compound and where said carrier plastics compound comprises a monomer, oligomer, prepolymer or any combination thereof, a curing agent may be provided to effect cross linking of said carrier plastics compound during reactive compounding.

If required, said thermoplastic matrix polymer may comprise one or more matrix functional groups reactive with said carrier functional groups via chain extension or cross linking during reactive compounding to form a carrier/matrix copolymer between said carrier plastics compound and said matrix polymer.

Suitably, the thermoplastic polymer is selected from the group comprising:—

crystalline polar thermoplastic polymers, crystalline non-polar thermoplastic polymers, non-crystalline non-polar thermoplastic polymers non-crystalline polar thermoplastic polymers; copolymers thereof or any combination of the aforesaid polymers.

The process may comprise the reaction, during reactive compounding, of a reactive polymer having at least one segment thermodynamically miscible with said matrix polymer and at least one segment having at least one reactive polymer functional group reactive with a carrier functional group to form a carrier/reactive copolymer between said carrier plastics compound and said reactive polymer.

The reactive polymer may be selected from a group comprising blocks, segments or chains having the same monomer unit as said matrix polymer or are thermodynamically miscible with said matrix polymer.

Suitably said carrier/reactive copolymer functions as a compatibilizer for said carrier plastics compound and said matrix polymer.

If required said reactive polymer may function as a curing agent for said plastics carrier compound during reactive compounding.

### BRIEF DESCRIPTION OF THE DRAWINGS

In order that the various aspects of the invention may be more fully understood and put into practical effect, reference will now be made to various embodiments described and exemplified herein and with further reference to the accompanying drawings in which:—

FIG. 1 shows an optical micrograph of polished surface of epoxy DER332/organoclay (epoxy/Cloisite 93A) nanocomposites (clay content of 2.5 wt %), of the prior art. (Scale bar: right: 50 μm);

FIG. 2 shows an optical micrograph of polished surface of epoxy DER332/pristine clay nanocomposites (clay content of 2.5 wt %). (Scale bar: right: 50 μm);

FIG. 3 shows a TEM micrograph of the epoxy DER332/organoclay (epoxy/Cloisite 93A) nanocomposites (clay content of 2.5 wt %) of the same prior art shown in FIG. 1;

FIG. 4 shows a TEM micrograph of epoxy DER332/pristine clay nanocomposites (clay content of 2.5 wt %);

FIG. 5 shows the mechanical properties of epoxy DER332/pristine clay nanocomposites exhibited by Young's modulus values;

FIG. 6 shows the mechanical properties of epoxy DER332/pristine clay nanocomposites exhibited by fracture toughness;

FIG. 7 shows the comparison of the Young's Modulus of pristine clay nanocomposites prepared with different method;

FIG. 8 shows the comparison of the fracture toughness of pristine clay nanocomposites prepared with different method;

FIG. 9 comprises the storage modulus, E′ versus temperature for neat epoxy, epoxy DER332/pristine clay nanocomposites and that of an epoxy DER332/organoclay nanocomposite (epoxy/Cloisite 93A) of the prior art;

FIG. 10 comprises the tan δ versus temperature for epoxy DER332/pristine clay nanocomposites and that of an epoxy DER332/organoclay nanocomposite (epoxy/Cloisite 93A);

FIG. 11 shows light transmittance of pristine clay nanocomposites various clay concentrations. Curves a,b,c and d are at 1.0, 2.5, 3.5 and 5.0 wt % clay respectively;

FIG. 12 shows a comparison of light transmittance according to prior art approach. (Ref: Deng, et al., Polymer International, 2004, 53, 85-91);

FIG. 13 shows a TEM micrograph of epoxy LY5210/pristine clay nanocomposites (clay content of 2.5 wt %);

FIG. 14 shows the storage modulus, E′ versus temperature for epoxy LY5210/pristine clay nanocomposites;

FIG. 15 shows the tan δ versus temperature for epoxy LY5210/pristine clay nanocomposites of the invention. In FIGS. 13 and 14, curve a is neat epoxy, curves b and c are 2.5 and 5.0 wt % clay respectively;

FIG. 16 shows the mechanical properties of epoxy LY5210/pristine clay nanocomposites using fracture toughness;

FIG. 17 shows a TEM micrograph of epoxy DER332/pristine clay nanocomposites (clay content of 2.5 wt %);

FIG. 18 shows a TEM micrograph of epoxy DER332/pristine clay nanocomposites (clay content of 2.5 wt %);

FIG. 19 compares XRD analyses of raw clay, a polypropylene/pristine clay nanocomposite according to the invention and a polypropylene/organoclay nanocomposite;

FIG. 20 shows comparative optical micrographs of PP/organoclay and PP/pristine clay nanocomposites according to the invention; and

FIG. 21 shows TEM micrographs of PP/organoclay and PP/pristine clay according to the invention.

FIG. 22 shows XRD patterns of raw clay and a SMA/pristine clay nanocomposite sample according to the invention;

FIG. 23 shows a TEM micrograph of styrene-maleic anhydride (SMA) copolymer/pristine clay according to the invention.

### DETAILED DESCRIPTION OF THE DRAWINGS

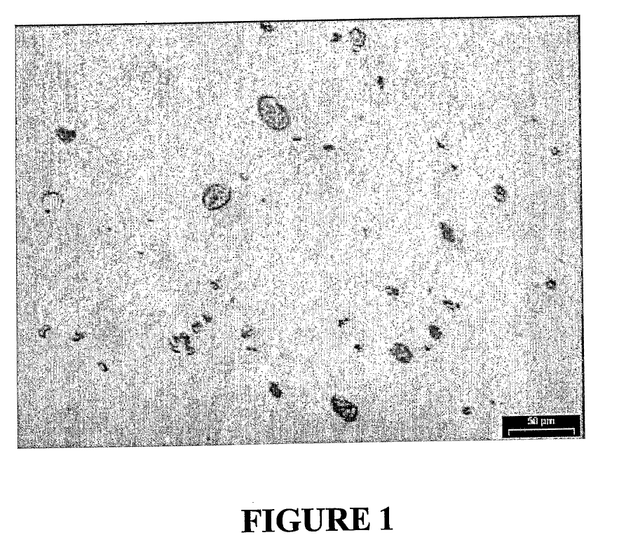

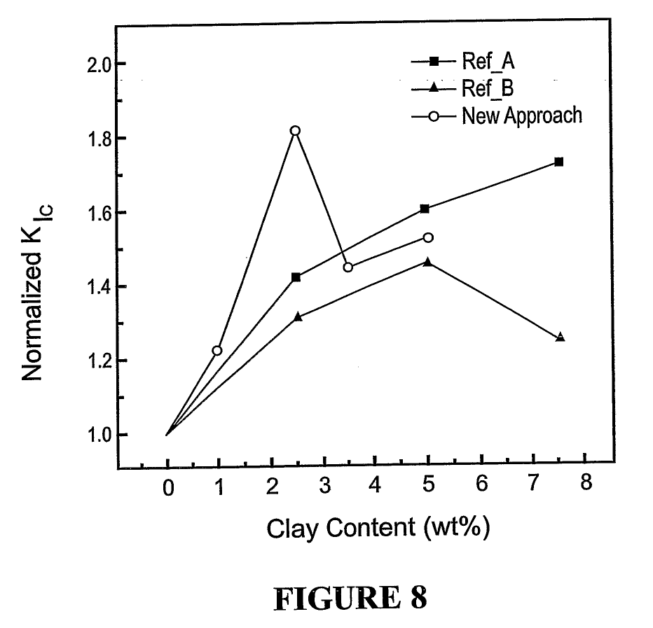

In the accompanying drawings, FIGS. 1 to 18 deal with prior art comparisons and illustrations of a novel method of preparing a clay masterbatch from a pristine clay and a carrier plastics compound having one or more functional groups.

The manufacture of pristine clay masterbatches is described in co-pending patent application PCT/SG2004/000212 to the same applicant and the contents thereof are incorporated herein by cross-reference and disclosure.

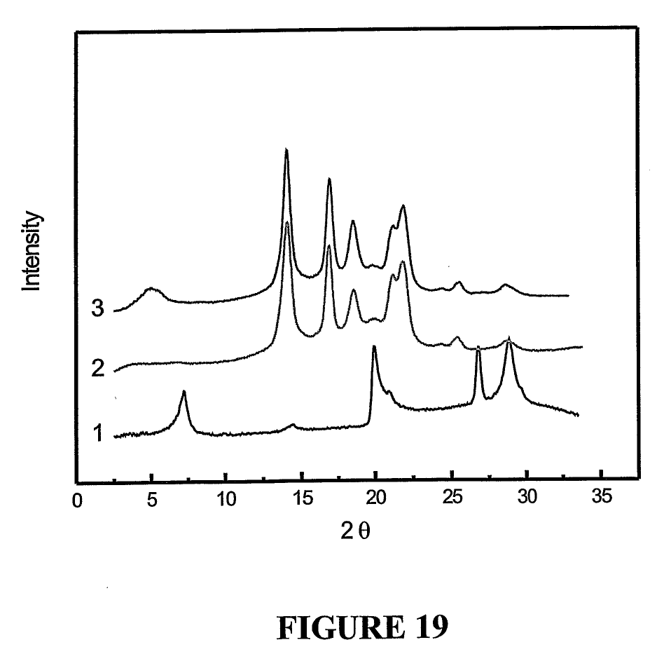

FIGS. 19 to 23 are directed to the preparation of thermoplastic polymer/pristine clay composites according to the present invention.

In preparation of the clay masterbatch, the pristine clay is first dispersed in water to form a dispersion. This causes swelling of the individual clay particles by penetration of the water into the clay gallery spaces.

The water dispersion is then exchanged with an organic solvent. The choice of solvent and the conditions of exchange are such that the swollen state of the clay is maintained. By using an organic solvent, the amount of modifiers can be reduced while exfoliation of the clay particles is improved. Substantially complete exfoliation can be achieved in at least the preferred forms of the process.

The organic solvent used in this process facilitates the reaction between the modifier and the clay and also facilitates the uniform dispersion of the clay layers in the monomers, oligomers or polymers. The organic solvent can also act as a solvent for such monomers, oligomers or polymers.

The organic solvent can be a polar or non-polar solvent. If it is non-polar and is not miscible with water, it will usually be used with a polar solvent. By such a solvent system, compatibility of the system with the hydrophilic clay layers and the hydrophobic molecules which may be used as a modifier or as the monomer, polymer or oligomer can be achieved.

The organic solvent is preferably of a low boiling point in order that the reactions are conducted at a low temperature and so that the solvent after performing its function can be easily removed by evaporation.

The organic solvents will thus be preferred including, but are not limited to ketones such as acetone, methyl ethyl ketone, methyl isobutyl ketone and cyclohexanone; alcohols such as methanol, ethanol, propanol, n-butanol, i-butanol, sec-butanol and tert-butanol; glycols such as ethylene glycol, propylene glycol and butylene glycol; esters such as methyl acetate, ethyl acetate, butyl acetate, diethyl oxalate and diethyl malonate; ethers such as diethyl ether, ethylene glycol dimethyl ether, diethylene glycol dimethyl ether and tetrahydrofuran; halogenated hydrocarbons such as dichloromethane, 1,2-dichloroethane, 1,4-dichlorobutane, trichloroethane, chlorobenzene and o-dichlorobenzene; hydrocarbons such as hexane, heptane, octane, benzene, toluene and xylene. Others include N-methyl-2-pyrrolidone, N,N-dimethylacetamide, N,N-dimethylformamide, dimethyl sulfoxide, tetramethylurea, hexamethylphosphoric triamide, and gamma-butyrolactone. These solvents may be used either singly or in any combination thereof. A solvent or a combination thereof with a boiling point below 100° C. is generally preferred for ease of handling and low cost.

In the process, the clay is first mixed with water. The ratio of clay to water can vary from 1:1 to 1:1000. Preferably from 1:2 to 1:500, more preferably from 1:5 to 1:200.

The ratio of the amount of water to the amount of organic solvent can vary widely as long as the clay remains in a swollen state. The amounts can vary from 1:1 to 1:50.

The clay used in the formation of the nanocomposites is one generally utilised in the prior art. Thus it can be selected from the group consisting of smectite and kaolin clays. Smectite clays for use in the current invention can be selected from the group consisting of montmorillonite, hectorite, saponite, sauconite, beidellite, nontronote, and combinations of two or more thereof. More preferably the clay is selected from the group consisting of hectorite, montmorillonite, beidellite, stevensite, and saponite. Typically the clay used in the current invention will have a cation-exchange capacity ranging from about 7 to 300 meq/100 g.

The amount of clay used in the nanocomposites of the current invention will vary depending upon the desired properties in the final nanocomposite and generally range from about 0.1% to 80% by weight based on the total weight of the composition with the higher values, 40 weight % to 80 weight % being employed in clay masterbatch compositions.

The organic modifiers used in the process can be those referred to in the prior art. The modifiers normally have a function to react with the clay surface and with the polymer chains. The clay surfaces are hydrophilic. The polymer chain can vary from hydrophobic to having some degree of hydrophilicity. The modifier will have both a hydrophilic and a hydrophobic functional group. Hence the modifier can be selected from the group consisting of surfactants, coupling agents and compatibilizers. Suitable modifiers can be selected from alkylammonium salts, organosilanes, alkyl acids (or functional derivatives thereof, such as an acid chloride or anhydride), grafted copolymers and block copolymers. In each case the modifier will be selected so that it has a functional group that can bond to the clay layers and another functional group that can bond to the polymer. It is a feature of the masterbatch process that the modifier can be used in a much lower amount than proposed in the prior art methods. Hence, the amount of modifier can be reduced to an amount within the range 0.15 to 15 weight percent.

The polymer can be selected from any polymers normally used in a composite in the prior art. Hence polymers chosen from thermosetting polymers, thermoplastic polymers, and combinations thereof can be employed. The polymers can be incorporated in the process as a polymerizable monomer, oligomer or prepolymer and then later polymerized in a reactive compounding process. Such polymers include thermosetting polymers such as epoxies, polyester resins and curing rubbers; thermoplastic polymers such as polyolefins which can consist of polyethylenes, polypropylenes, polybutylenes, polymethylpentene, polyisoprenes and copolymers thereof, copolymers of olefins and other monomers such as ethylene-vinyl acetate, ethylene acid copolymers, ethylene-vinyl alcohol, ethylene-ethyl acrylate, and ethylene-methyl acrylate, polyacrylates such as polymethyl methylacrylate, polybutyl acrylate, polyethyl methacrylate, polyisobutyl acrylate, poly(2-ethylhexyl acrylate), poly(amino acrylates), poly(hydroxyethylmethacrylate), poly(hydroxypropyl methacrylate), or other polyalkyl acrylates; polyesters such as polyarylates, polybutylene terephthalate and polyethylene terephthalate; polystyrene and copolymers such as ABS, SAN, ASA and styrene-butadiene; engineering resins such as polycarbonate, polyetherimide, polyetheretherketone, polyphenylene sulphide and thermoplastic polyimides; elastomers such as olefinic TPE's, polyurethane TPE's, and styrenic TPE's; chlorinated polymers such as PVC and polyvinylidene dichloride; silicones such as polydimethyl siloxane, silicone rubber, silicone resin; fluoropolymers and copolymers with other monomers are useful such as polytetrafluoroethylene, fluorinated ethylene-propylene, perfluoroalkoxy resins, polychlorotrifluoroethylene, ethylene-chlorofluoroethylene copolymer, polyvinylidene fluoride and polyvinylfluoride. Additional polymers are nitrile resins, polyamides (nylons), polyphenylene ether and polyamide-imide copolymers. Also included are the sulfone based resins such as polysulfone, polyethersulfone and polyarylsulfone. Other families of thermoplastic resins useful in this process are acetals, acrylics and cellulosics. Liquid crystal polymers, a family of polyester copolymers, can also be used. In addition, miscible or immiscible blends and alloys of any of the above resin combinations are useful.

The amount of polymer in the composite masterbatch can vary from about 20% up to about 80% by weight of the total composition depending on the desired application. The preferred polymer content can be 40% to 80%; more preferably 50% to 60%.

Example 1 illustrates the manufacture of a clay masterbatch using a prior art modified clay.

Examples 2 to 5 illustrate the manufacture of clay masterbatches for use with nanocomposites and processes for the manufacture thereof in accordance with the present invention.

Examples 6 and 7 illustrate the manufacture of thermoplastic nanocomposites according to the present invention.

### EXAMPLE 1

2 grams of Cloisite 93A, an commercial organoclay containing 40 wt % of an alkylammonium surfactant was mixed with 60.8 g of Dow epoxy resin DER 332 by using a homogenizer for 2 hours at a speed of 10000 rpm. The mixture then mixed with 16 g curing agent (ETHACURE 100LC) by stirring and cured at 100° C. for 2 hours and 180° C. for 5 hours. The final product was a plate and subject to a number of tests.

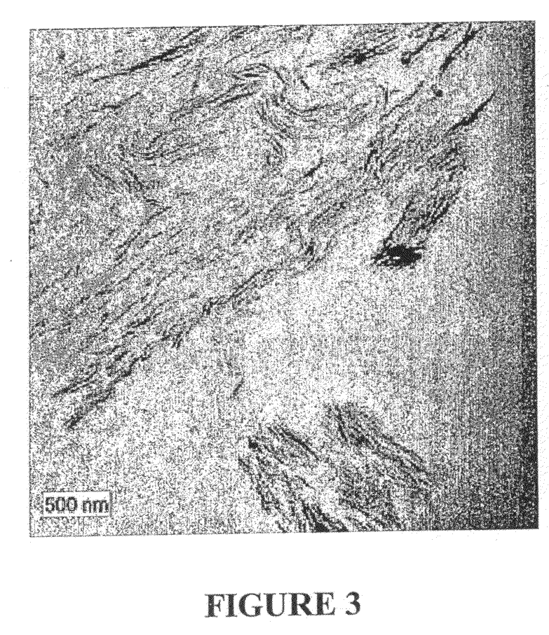

The optical micrograph is shown in FIG. 1. The TEM micrograph is shown in FIG. 3.

### EXAMPLE 2

2 grams of purified sodium montmorillonite having a cation exchange capacity of 145 meq/100 g, was mixed with 100 ml of water, with stirring for 24 hours at room temperature to form a suspension. The suspension was precipitated in 1000 ml of acetone at room temperature with stirring and washed with acetone at room temperature for 3 times. 3-aminopropyltrimethoxy-silane was added as the coupling agent in an amount of 0.1 g. The mixture was then stirred for 12 hours at room temperature. Then 60.8 g of Dow epoxy resin DER 332 was mixed with the modified clay thoroughly by using a homogenizer for 2 hours at a speed of 10000 rpm. The mixture was dried in a vacuum oven at 50° C. for 48 hours and then mixed with 16 g curing agent (ETHACURE 100 LC) by stirring and cured at 100° C. for 2 hours and 180° C. for 5 hours. The final product was a plate and subject to a number of tests.

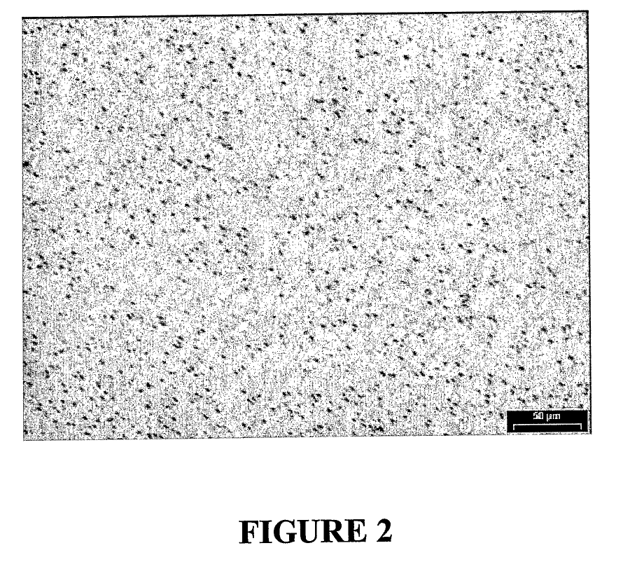

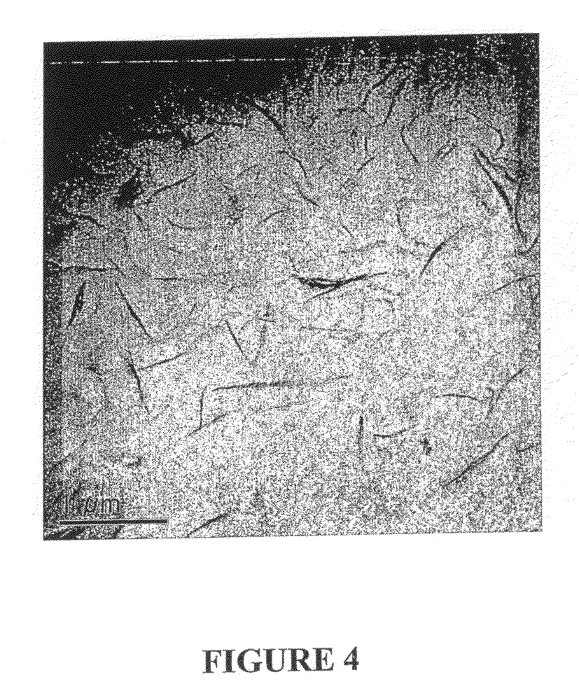

The optical micrograph is shown in FIG. 2. The TEM micrograph is shown in FIG. 4.

Optical microscope (OM) observations confirmed that the clay particles have uniformly dispersed in the matrix in the nanocomposites prepared with the dispersion technique. In an epoxy/organoclay composite prepared with a prior art technique, the aggregate size is 10-20 micron (FIG. 1). In the above-mentioned epoxy/clay nanocomposite, clay particles are uniformly dispersed in the matrix and the size of the aggregates is less than 1 micron (FIG. 2).

The results of a transmission electron microscopic (TEM) study show that the clay is highly exfoliated and the clay layers are uniformly dispersed in the epoxy matrix (FIG. 4), which is significantly superior to that of the samples made with the prior art technique (FIG. 3).

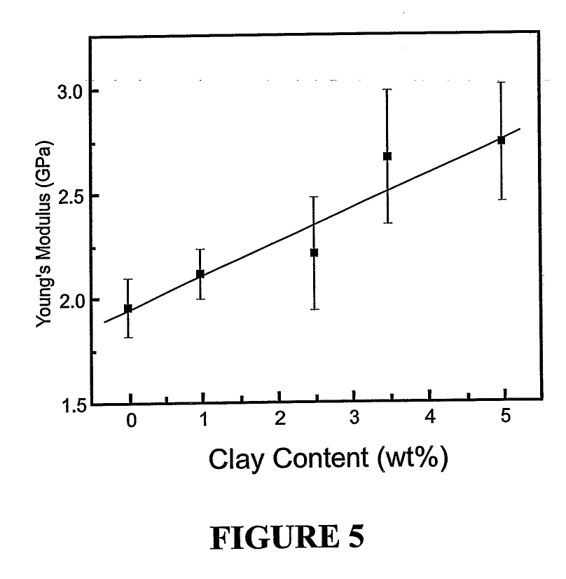

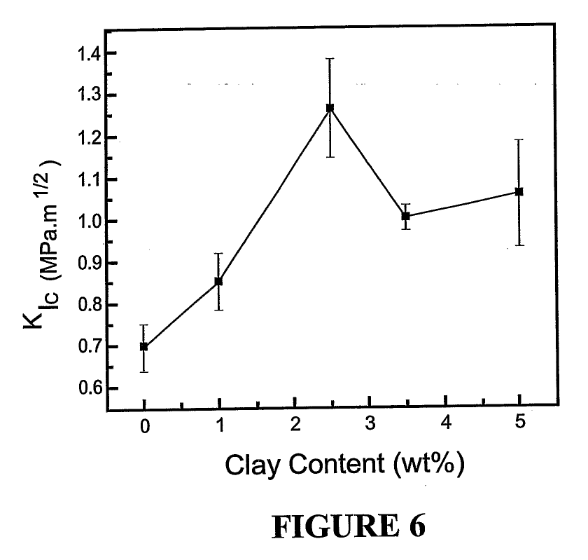

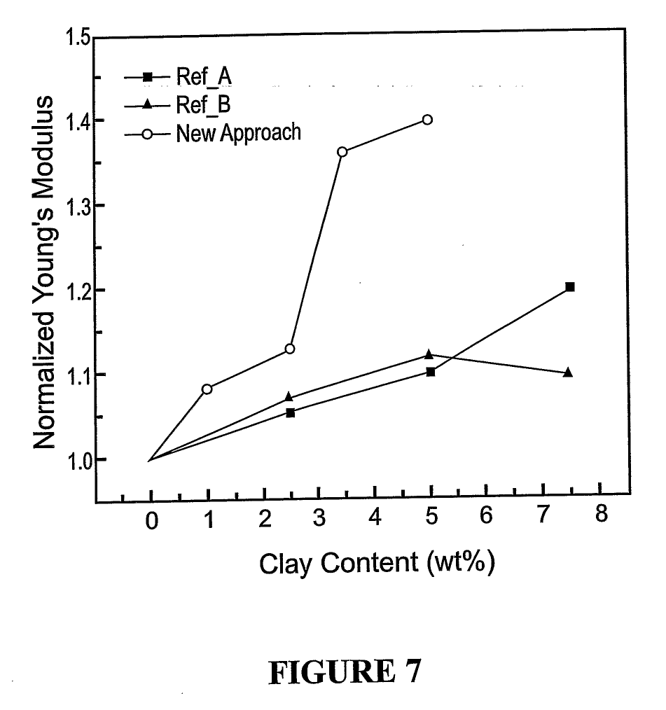

The incorporation of clay into epoxy improves both the Young's modulus (FIG. 5) and fracture toughness (FIG. 6). At a clay load of 2.5 wt %, the fracture toughness shows a maximum value (FIG. 6). Compared with the data reported in literature, the nanocomposites prepared with this approach show better performance in terms of both Young's modulus and fracture toughness. FIGS. 7 and 87 show, respectively, the comparison of the Young's Modulus and fracture toughness of the nanocomposites of the invention prepared in accordance with a different method. (Ref: Becker, Cheng, Varley, Simon. Macromolecules, 2003, 36, 1616-1625). Ref A was cured at 100° C. 2 h, 130° C. 1 h, 160° 12 h, 200° C. 2 h. Ref B was cured at 160° C. 12 h, 200° C. 2 h. It is obvious that the nanocomposites prepared with this approach show higher Young's modulus regardless of the clay content. The maximum value of fracture toughness is higher than that of the samples prepared with the prior art approach.

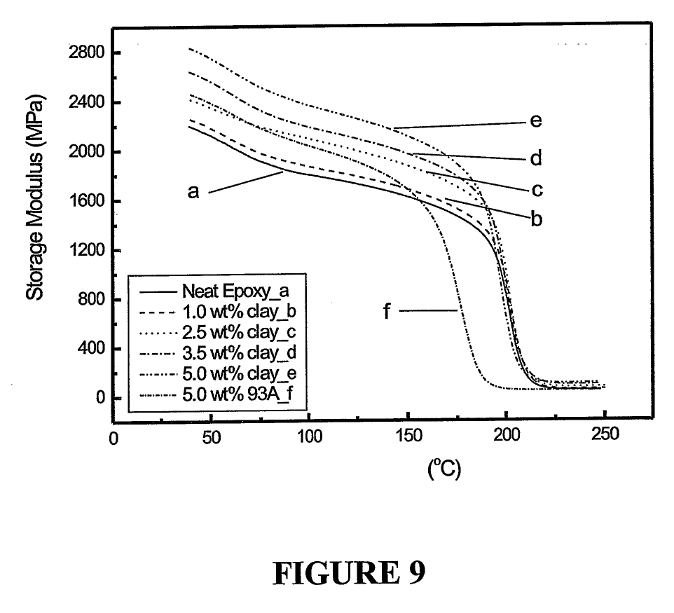

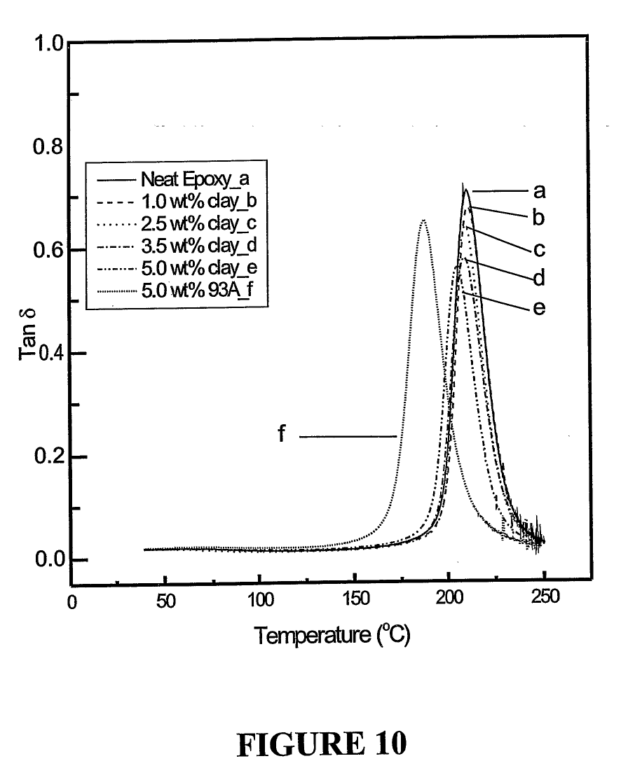

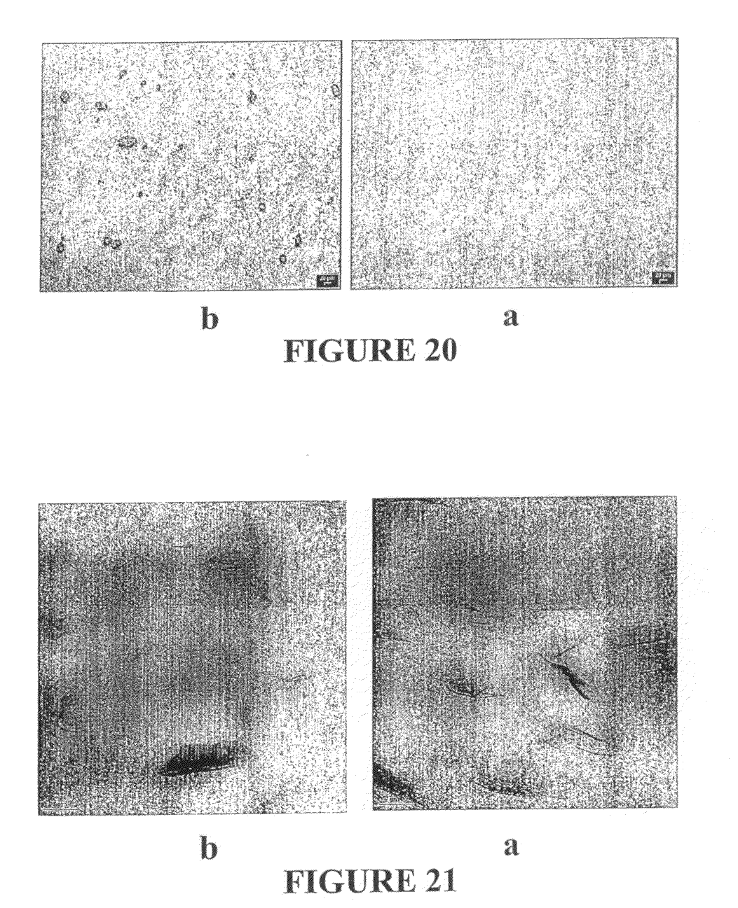

The dynamic mechanical properties of the nanocomposites are shown in FIGS. 9 and 10, together with that of an epoxy/organoclay nanocomposite (epoxy/93A). In FIGS. 9 and 20, curve a is neat epoxy, curves b, c, d and e are 1.0, 2.5, 3.5 and 5 wt % clay respectively. Curve f represents 5.0 wt % of Cloisite 93A. It can be seen that the storage modulus of the nanocomposites with this approach increase with the clay load, while the Tg didn't change much. For epoxy/organoclay, however, the storage modulus is lower at the same load, and the Tg decrease dramatically.

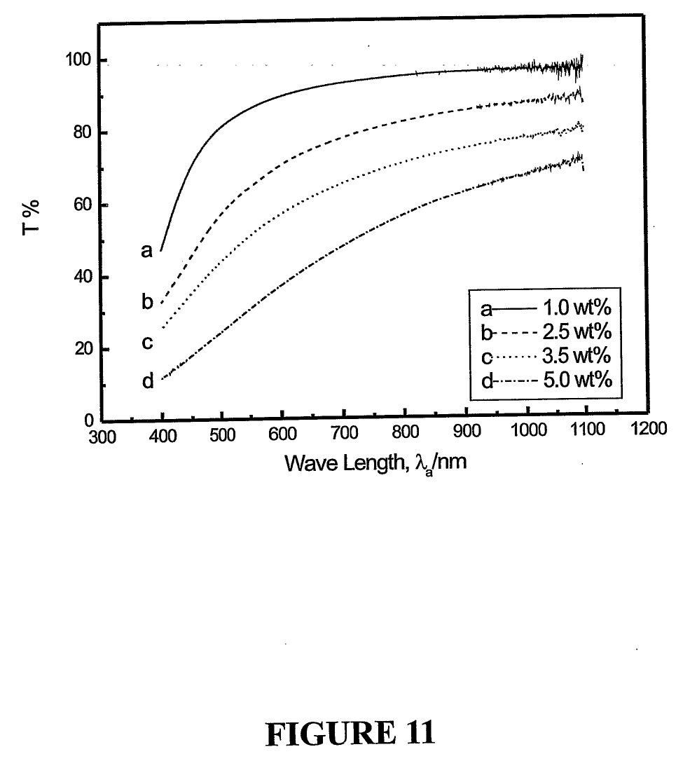

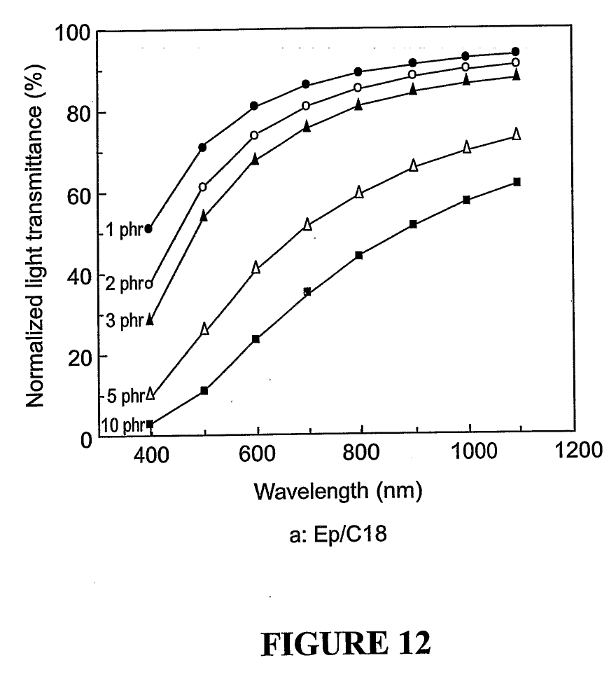

FIGS. 11 and 12 show a comparison of high transmittance. Because the clay dispersion and exfoliation have been improved with this approach, the transmittance of the new epoxy/clay nanocomposites (FIG. 11) is better than that of the nanocomposites prepared with the prior art approaches (FIG. 12).

### EXAMPLE 3

2 grams of purified sodium montmorillonite having a cation exchange capacity of 145 meq/100 g, was mixed with 100 ml of water, with stirring for 24 hours at room temperature to form a suspension. The suspension was precipitated in 1000 ml of acetone at room temperature with stirring and washed with acetone at room temperature for 3 times. 3-glycidopropyltrimethoxy-silane was added as the coupling agent in an amount of 0.1 g. The mixture was then stirred for 12 hours at room temperature. Then 50 g of Ciba epoxy resin LY5210 was mixed with the modified clay thoroughly by using a homogenizer for 2 hours at a speed of 10000 rpm. The mixture was dried in a vacuum oven at 50° C. for 48 hours and then mixed with 25 g curing agent (Ciba HY2954) by stirring and cured at 160° C. for 2 hours and 220° C. for 2 hours. The final product was a plate and subject to a number of tests.

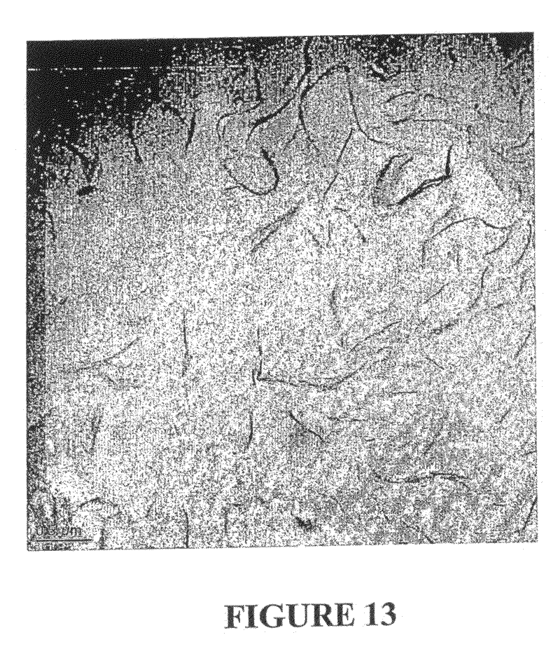

The TEM micrograph shows that the clay is highly exfoliated and the clay layers are uniformly dispersed in the epoxy matrix (FIG. 13), which is significantly superior to that of the samples made with the prior art technique (FIG. 3).

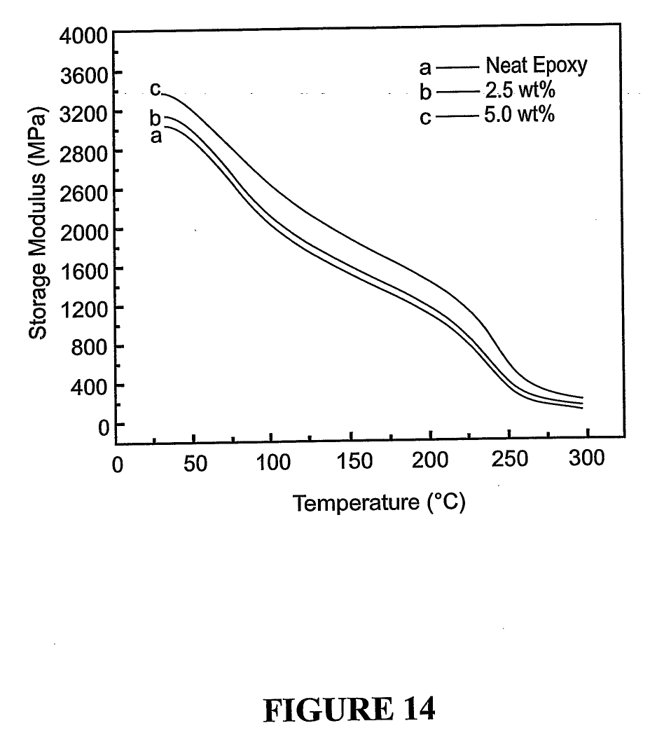

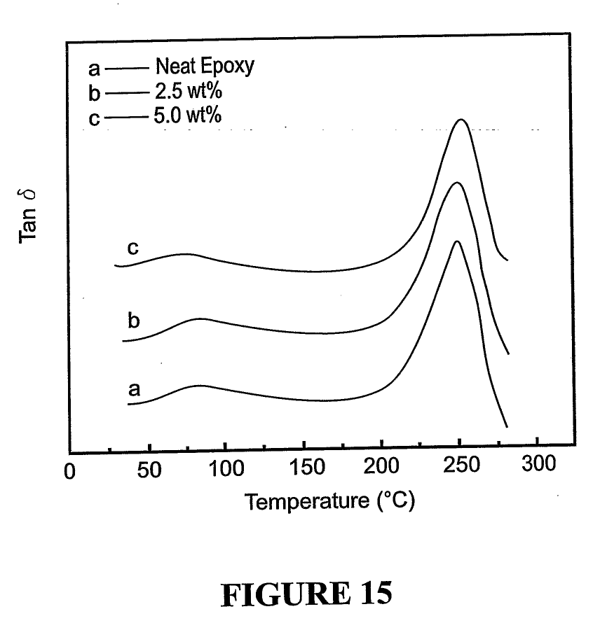

The dynamic mechanical properties of the nanocomposites are shown in FIGS. 14 and 15. It can be seen that both the storage modulus and Tg of the nanocomposites made by this approach increase with the clay load.

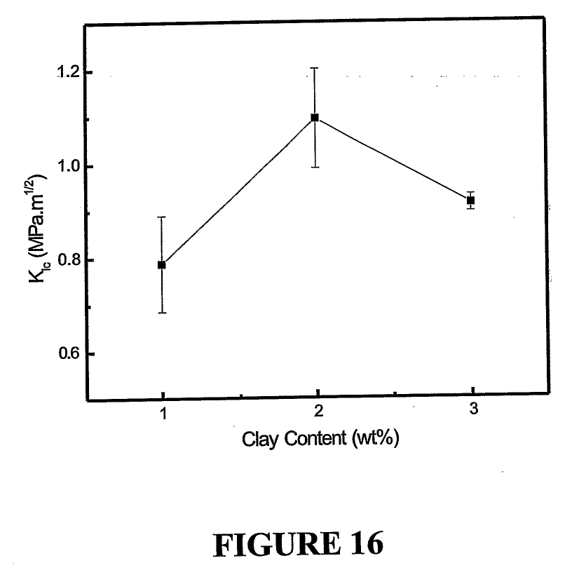

The incorporation of clay into epoxy improves fracture toughness (FIG. 16). At a clay load of 2.5 wt %, the fracture toughness shows a maximum value.

### EXAMPLE 4

2 grams of purified sodium montmorillonite having a cation exchange capacity of 145 meq/100 g, was mixed with 100 ml of water, with stirring for 24 hours at room temperature to form a suspension. The suspension was precipitated in 1000 ml of ethanol at room temperature with stirring and washed with ethanol at room temperature for 3 times. 3-aminopropyltrimethoxy-silane was added as the coupling agent in an amount of 0.1 g. The mixture was then stirred for 12 hours at room temperature. Then 60.8 g of Dow epoxy resin DER 332 was mixed with the modified clay thoroughly by using a homogenizer for 2 hours at a speed of 10000 rpm. The mixture was dried in a vacuum oven at 60° C. for 48 hours and then mixed with 16 g curing agent (ETHACURE 100 LC) by stirring and cured at 100° C. for 2 hours and 180° C. for 5 hours. The final product was a plate and subject to a number of tests.

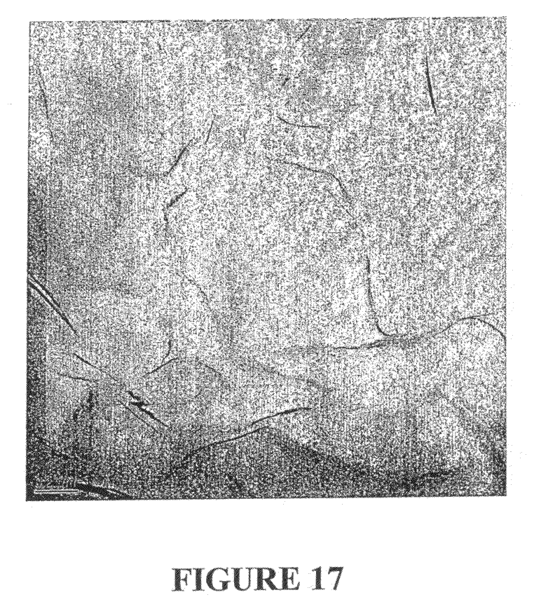

The TEM micrograph show that the clay is highly exfoliated and the clay layers are uniformly dispersed in the epoxy matrix (FIG. 17), which is significantly superior to that of the samples made with a prior art technique (FIG. 3).

### EXAMPLE 5

2 grams of purified sodium montmorillonite having a cation exchange capacity of 145 meq/100 g, was mixed with 100 ml of water, with stirring for 24 hours at room temperature to form a suspension. The suspension was precipitated in 1000 ml of acetone at room temperature with stirring and washed with acetone at room temperature for 3 times. 3-glycidopropyltrimethoxy-silane was added as the coupling agent in an amount of 0.1 g. The mixture was then stirred for 12 hours at room temperature. Then 60.8 g of Dow epoxy resin DER 332 was mixed with the modified clay thoroughly by using a homogenizer for 2 hours at a speed of 10000 rpm. The mixture was dried in a vacuum oven at 50° C. for 48 hours and then mixed with 16 g curing agent (ETHACURE 100 LC) by stirring and cured at 100° C. for 2 hours and 180° C. for 5 hours. The final product was a plate and subject to a number of tests.

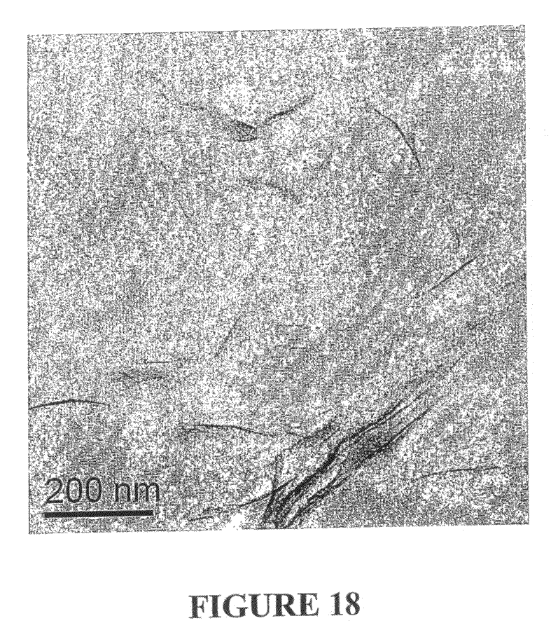

The TEM micrograph show that the clay is highly exfoliated and the clay layers are uniformly dispersed in the epoxy matrix (FIG. 18), which is significantly superior to that of the samples made with a prior art technique (FIG. 3).

The following table summarises the main components used in each of the Examples and the relevant Figures illustrating the properties of the final product.

TABLE 1

| | Polymer | | | | |
|---|---|---|---|---|---|
| Examples | Matrix | Clay | Solvent | Modifier | Figures |
| 1 | DER332 | Organo | None | None | 1, 3 |
| | | clay | | | |
| 2 | DER332 | Pristine | Acetone | 3-aminopropyl- | 2, 4-12 |
| | | clay | | trimethoxy- | |
| | | | | silane | |
| 3 | LY 5210 | Pristine | Ethanol | 3-glycidopropyl- | 13-16 |
| | | clay | | trimethoxy- | |
| | | | | silane | |
| 4 | DER332 | Pristine | Ethanol | 3-aminopropyl- | 17 |
| | | clay | | trimethoxy- | |
| | | | | silane | |
| 5 | DER332 | Pristine | Acetone | 3-glycidopropyl- | 18 |
| | | clay | | trimethoxy- | |
| | | | | silane | |

### EXAMPLE 6

a) Initially, a 20 weight % masterbatch was prepared in accordance with the method described in EXAMPLE 5 except that the curing agent was omitted. As in EXAMPLE 5, the carrier plastics compound was an epoxy (DER 332) compound.

5 grams of the masterbatch so prepared was then melt compounded with 32 grams of a general purpose (Titanpro) 6331 grade polypropylene (PP) homopolymer and 8 grams of (Eastman Epolene) maleic anhydride grafted polypropylene (PP-g-MAH) grade G3003 in a Brabendar mixer at 190° C. with a rotational speed of 100 rpm for 10 minutes.

(b) For comparative purposes, a reference sample was prepared by melt compounding 1 gram of (Nanocor Nanomer) 130P organoclay with 40 grams of (Titanpro) 6331 grade PP and 4 grams of (Eastman Epolene G3003) PP-g-MAH at 190° C. with a rotational speed of 100 rpm for 10 minutes.

Referring to FIG. 19, which represents XRD spectra for raw clay (curve 1), sample a (curve 2) and sample b (curve 3), it can be concluded that the organoclay containing sample (b) exhibits a highly intercalated structure because the (001) peak of clay reflects strongly albeit at a lesser angle than for raw clay. In contrast the (001) peak disappears from the reflectance curve for the pristine clay example (a) thus suggesting an absence of intercalated tactoids and the likelihood of a highly exfoliated clay dispersion in sample a according to the invention.

FIG. 20 shows comparative optical micrographs for samples a and b wherein the aggregate particle size of the clearly visible tactoids or undispersed disordered layers for sample b is in the range of from 10 to 20 μm compared with far more uniformly dispersed clay particles in sample a wherein the aggregate particle size is less than 1 μm.

FIG. 21 is a comparison between TEM micrographs for samples a and b showing clearly that the clay particles in sample a are more highly exfoliated and more uniformly dispersed than in sample b which represents a prior art technique for nanocomposite manufacture using an organoclay filler.

### EXAMPLE 7

A 20 weight % masterbatch was prepared in accordance with the method described in EXAMPLE 5 except that the curing agent was omitted. As in EXAMPLE 5, the carrier plastics compound was an epoxy (DER 332) compound.

5 grams of the masterbatch so prepared was then melt compounded with 45 grams of a styrene-maleic anhydride (SMA) copolymer (Dylark 322, Nova Chemicals) in a Brabendar mixer at 190° C. with a rotational speed of 100 rpm for 10 minutes.

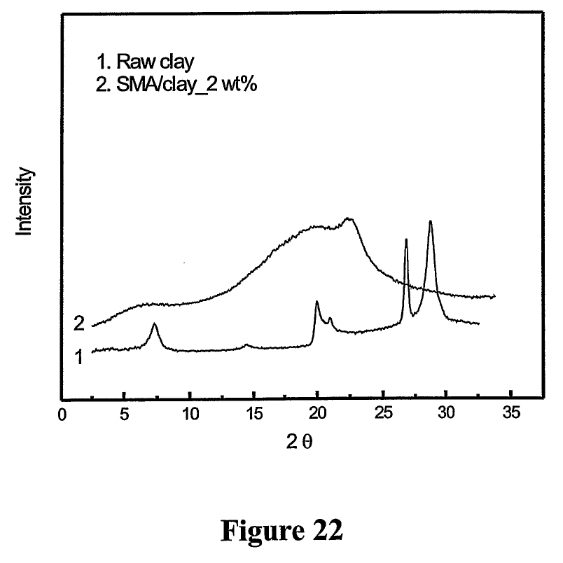

Referring to FIG. 22, which represents XRD spectra for raw clay (curve 1) and the SMA/clay nanocomposite (curve 2), it can be concluded that the SMA/clay nanocomposite exhibits a highly exfoliated structure because the (001) peak of clay reflects disappears.

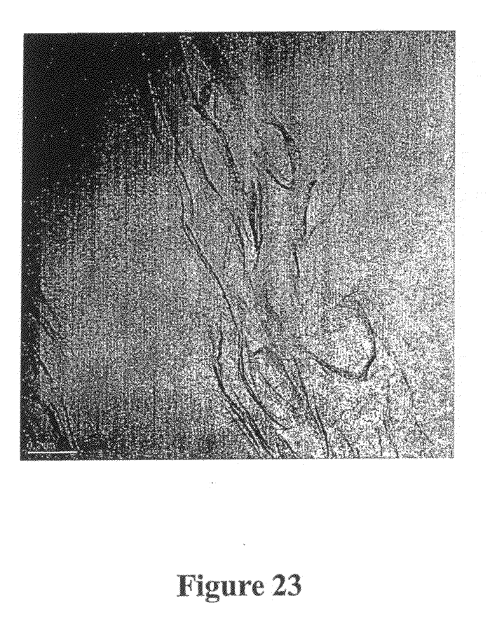

FIG. 23 shows a TEM micrograph of the SMA/clay nanocomposite sample. Clearly, the clay particles in the sample are highly exfoliated.

It readily will be apparent to a person skilled in the art that many modifications and variations may be possible without departing from the spirit and scope of the various aspects of the invention.

Similarly, equally it will be apparent to a person skilled in the art that the nanocomposites of the present invention offer substantial advantages over prior art nanocomposite materials and processes for the production thereof.

By employing the novel and versatile masterbatch of our co-pending patent application PCT/SG2004/000212 with a thermoplastic polymer matrix, with or without a reactive copolymer, in a reactive compounding process, a wide range of thermoplastic polymer matrices may be employed including non-polar polymers such as polyolefins including polyethylenes, polypropylenes, polystyrenes, polyurethanes as well as styrene based thermoplastic elastomers including acrylonitrile butadiene styrene (ABS) and the like. Moreover the invention is also applicable to poly (methylmethacrylate) (PMMA), poly (ethyleneterephthalate) (PET), poly (butyleneterephthalate) (PBT), polycarbonates, polyamides and the like.

A particular advantage arises from the use of pristine clay masterbatches made in accordance with our co-pending patent application PCT/SG2004/000212 in that not only are the minimally modified substantially pristine clays substantially less expensive than prior art organoclays, they are not contaminated with low molecular weight modifiers to the same extent as prior art products. Moreover, because the plastics carrier compound for the pristine clay masterbatch has a highly exfoliated clay dispersed within and because the plastics carrier compound is thermodynamically miscible or reactive with a wide variety of polymer matrices, the resultant thermoplastic nanocomposite is thermodynamically stable with superior physical properties arising from an evenly dispersed highly exfoliated pristine clay throughout.

A further advantage is that by utilizing a low clay modifier content in combination with a reactive plastics carrier compound, selective chain extension or cross linking reactions between carrier compounds and matrix polymers, with or without the presence of a reactive copolymer, substantially minimize the presence of low molecular weight polymer species in the nanocomposite material.

Table 2 represents a comparison of prior art nanocomposite materials with nanocomposites according to the invention.

TABLE 2

| | Prior Art | Nanocomposites of |
|---|---|---|
| | Nanocomposite | the invention |
| Clay type | Organoclay | Pristine clay |
| Amount of organic | 1.7 to 4.1 wt % | 0.1 to 0.5 wt % |
| modifier* | | |
| Function of copolymer | Compatibilizer | Curing agent and |
| (if used) | | Compatibilizer |
| Reaction during | None | Yes |
| compounding | | |
| Low MW additives in | Unchanged | Chemically bonded |
| product | | |
| Dispersion of clay | Fair | Very good |
| Applicability | Matrix-specific | Versatile |
| Colour of product | Brown | Light grey |
| Cost | High | Low |

*in final nanocomposite if true clay content is 5.0 wt %.

* in final nanocomposite if true clay content is 5.0 wt %.

Nanocomposites according to the invention will have wide application in injection moulded, extruded or thermoformed articles where high elastic modulus, high tensile strength, high impact resistance, high hardness, high heat distortion temperatures, high thermal stability, good clarity and improved gas barrier properties are required. Such articles may find application as parts and components in the automotive, automobile or general engineering industries as well as beverage and food packaging.

1. A thermoplastic polymer based nanocomposite prepared by reactive compounding of:—
a nanocomposite masterbatch comprising a carrier plastics compound having one or more carrier functional groups and an exfoliated clay dispersed throughout said carrier plastics compound; and,
a thermoplastic matrix polymer, said matrix polymer having a main chain directly or indirectly miscible with or reactive with said carrier plastics compound.

2. A nanocomposite as claimed in claim 1 wherein said carrier plastics compound comprises a monomer, oligomer or polymer or any combination thereof.

3. A nanocomposite as claimed in claim 1 wherein said one or more carrier functional groups are selected from epoxy, hydroxyl, amine, isocyanate, carboxyl or any combination thereof.

4. A nanocomposite as claimed in claim 1 wherein said carrier plastics compound comprises an epoxy prepolymer or polyethylene oxide.

5. A nanocomposite as claimed in claim 1 wherein said thermoplastic matrix polymer is directly miscible with said carrier plastics compound and where said carrier plastics compound comprises a monomer, oligomer, prepolymer or any combination thereof, a curing agent is provided to effect cross linking of said monomer, oligomer, prepolymer or any combination thereof during reactive compounding of said nanocomposite.

6. A nanocomposite as claimed in claim 1 wherein said thermoplastic matrix polymer includes one or more matrix functional groups reactive with carrier functional groups via chain extension or cross linking during reactive compounding to form a carrier/matrix copolymer between said carrier plastics compound and said matrix polymer.

7. A nanocomposite as claimed in claim 1 wherein said thermoplastic polymer is selected from the group comprising:—
crystalline polar thermoplastic polymers, crystalline non-polar thermoplastic polymers, non-crystalline non-polar thermoplastic polymers, non-crystalline polar thermoplastic polymers; copolymers thereof or any combination of the aforesaid polymers.

8. A nanocomposite as claimed in claim 1 wherein said nanocomposite includes a reactive polymer having at least one segment thermodynamically miscible with said matrix polymer and at least one region having at least one reactive polymer functional group reactive with a carrier functional group during reactive compounding to form a carrier/reactive copolymer between said carrier plastics compound and said reactive polymer.

9. A nanocomposite as claimed in claim 8 wherein said at least one reactive polymer functional group is selected from carboxyl, anhydride, hydroxyl, isocyanine, amine, epoxy or any combination thereof.

10. A nanocomposite as claimed in claim 8 wherein said reactive polymer is selected from a group comprising blocks, segments or chains having the same monomer unit as said matrix polymer or are thermodynamically miscible therewith.

11. A nanocomposite as claimed in claim 1 wherein said masterbatch includes clay in an amount of from between 2% and 80% by weight of said masterbatch.

12. A nanocomposite as claimed in claim 1 comprising from 0.1% to 20% by weight of clay based on a total weight of the nanocomposite.

13. A nanocomposite as claimed in claim 1 wherein said nanocomposite masterbatch is formed by treatment of pristine clay with water to swell said clay, exchanging said water with an organic solvent while maintaining said clay in a swollen state, treating said solvent exchanged swollen clay with a modifier selected from a surfactant, a coupling agent, a compatibilizer or any combination thereof and subsequently mixing said clay so treated with a monomer, oligomer, polymer or combinations and selectively removing said solvent from said nanocomposite masterbatch.

14. A nanocomposite as claimed in claim 13 wherein said modifier is present in an amount of between 0.05-15 wt % of clay in said nanocomposite.

15. A process for the formation of a thermoplastic nanocomposite said process including reactive compounding of a nanocomposite masterbatch comprising a plastics carrier compound having one or more carrier functional groups and an exfoliated clay dispersed throughout said carrier plastics compound and a thermoplastic matrix polymer, said matrix polymer having a main chain directly or indirectly miscible with or reactive with said carrier plastics compound.

16. A process as claimed in claim 15 wherein said carrier plastics compound is selected from monomers, oligomers, polymers or any combination thereof.

17. A process as claimed in claim 15 wherein said carrier functional groups are selected from epoxy, hydroxyl, amine, isocyanate, carboxyl or any combination thereof.

18. A process as claimed in claim 15 wherein said carrier plastics compound comprises an epoxy prepolymer or polyethylene oxide.

19. A process as claimed in claim 15 wherein said thermoplastic matrix polymer is directly miscible with said carrier plastics compound and where said carrier plastics compound comprises a monomer, oligomer, prepolymer or any combination thereof, a curing agent is provided to effect cross linking of said carrier plastics compound during reactive compounding.

20. A process as claimed in claim 15 wherein said thermoplastic matrix polymer comprises one or more matrix functional groups reactive with said carrier functional groups via chain extension or cross linking during reactive compounding to form a carrier/matrix copolymer between said carrier plastics compound and said matrix polymer.

21. A process as claimed in claim 15 wherein said thermoplastic polymer is selected from the group comprising:—
crystalline polar thermoplastic polymers, crystalline non-polar thermoplastic polymers, non-crystalline non-polar thermoplastic polymers, non-crystalline polar thermoplastic polymers; copolymers thereof or any combination of the aforesaid polymers.

22. A process as claimed in claim 15 comprising a reaction, during reactive compounding, of a reactive polymer having at least one segment thermodynamically miscible with said matrix polymer and at least one segment having at least one reactive polymer functional group reactive with a carrier functional group to form a carrier/reactive copolymer between said carrier plastics compound and said reactive copolymer.

23. A process as claimed in claim 15 wherein said reactive polymer is selected from a group comprising blocks, segments or chains having the same monomer unit as said matrix polymer or are thermodynamically miscible therewith.

24. A process as claimed in claim 15 wherein said carrier/reactive copolymer functions as a compatibilizer for said carrier plastics compound and said matrix polymer.

25. A process as claimed in claim 15 wherein said reactive polymer functions as a curing agent for said plastics carrier compound during reactive compounding.

26. A process as claimed in claim 15 wherein said nanocomposite masterbatch is prepared by treating pristine clay with water to swell the clay, exchanging the water with an organic solvent whilst maintaining the clay in a swollen state, treating the swollen clay with a modifier selected from a surfactant, a coupling agent, a compatibilizer or any combination thereof and subsequently mixing said clay so treated with a monomer, oligomer, prepolymer or polymer or any combination thereof and selectively removing said solvent from said nanocomposite masterbatch.

27. A process as claimed in claim 26 wherein said modifier is present in an amount of between 0.05-15 wt % of clay in said nanocomposite.
